(19) United States
(12) Patent Application Publication
(10) Pub. No.: US 2016/0155321 A1
(43) Pub. Date: Jun. 2, 2016

(54) REMOTE CONTROL VIA MULTIPLE WIRELESS TRANSMISSION SCHEMA

(71) Applicant: GainSpan Corporation, San Jose, CA (US)

(72) Inventors: Lewis E. ADAMS, III, San Jose, CA (US); Pankaj VYAS, Bangalore (IN); Gregory A. WINNER, San Jose, CA (US)

(21) Appl. No.: 14/557,998

(22) Filed: Dec. 2, 2014

(51) Int. Cl. G08C 17/02; H04W 52/02; H04W 4/00

(52) U.S. Cl. CPC G08C 17/02; H04W 4/008; H04W 52/0225; G08C 2201/20

(57) ABSTRACT

A system includes a remote control, a device and a wireless network. The device is coupled to the remote control by a set of wireless communication protocols. The wireless network is coupled to the device by a set of wireless communication export protocols. The wireless communication protocols and the wireless communication export protocols include 802.11 WiFi, WiFi, ZigBee and Bluetooth.

### TECHNICAL FIELD

The present disclosure generally relates to wireless systems. More specifically, the present disclosure relates to remote control via multiple wireless transmission schema.

### BACKGROUND

For wireless systems or devices, transferring data efficiently while conserving power is a key concern. Wireless communication protocols such as ZigBee, Bluetooth and 802.11 WiFi may be used for different applications. However, certain protocols such as ZigBee or Bluetooth are more suited for low bandwidth, close-range communications with devices that may not require a network, whereas other protocols such as 802.11 WiFi may be better suited for high bandwidth, long-range communications with devices in a large and broad network.

Furthermore, some wireless communication protocols may utilize and consume more power when compared to other wireless communication protocols. A given wireless communication protocol is most ideally used when it communicates with a device within its target range. For instance, ZigBee and Bluetooth should be used for devices located at a closer range, with WiFi being used for devices located farther away. In addition, if a wireless communication protocol does not need to be turned on or have to send messages all the time, then shutting off the wireless communication protocol when it is not in use will conserve the most power.

Usually, devices such as remote controls may be used to send messages to a device. The messages may control the functionality of the device, or may simply turn the device on or off. The remote controls and the devices use wireless communication protocols in order to send and receive these messages. However, remote controls (as well as devices) may be left on for excessive periods of time. They may also not utilize the most efficient wireless communication protocol for interacting with one another. Therefore, an approach to manage the efficient remote control of devices over a wireless network is desired, in order to conserve the most power for wireless communications.

### SUMMARY

In one aspect, a system includes a remote control, a device and a wireless network. The device is coupled to the remote control by a set of wireless communication protocols. The wireless network is coupled to the device by a set of wireless communication export protocols.

Another aspect discloses a method using wireless communication protocols. The method includes receiving data on at least two wireless communication protocols. The method also includes performing actions based on the received data. The method also includes transmitting data to a wireless network on at least two wireless communication export protocols.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a schematic diagram of a device using various wireless communication protocols according to an aspect of the present disclosure.

FIG. 2 is a schematic diagram of a device in communication with a remote control and using various wireless communication protocols according to an aspect of the present disclosure.

FIG. 3 is a schematic diagram of a device in communication with a remote control and using various wireless communication protocols according to an aspect of the present disclosure.

FIG. 4 is a schematic diagram of a device in communication with a remote control and using various wireless communication protocols according to an aspect of the present disclosure.

FIG. 5 is a schematic diagram of a device in communication with a remote control and using various wireless communication protocols according to an aspect of the present disclosure.

FIG. 6 is a process flow diagram illustrating a method of using a remote control to communicate with a device using various wireless communication protocols, according to an aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

Overview

The present disclosure describes systems that use a remote control efficiently to communicate with a device over a wireless communication protocol (such as ZigBee, Bluetooth, or 802.11 WiFi), which may or may not utilize a wireless network. For wireless communication protocols such as ZigBee or Bluetooth, there is no wireless network involved, and the remote control simply communicates with the device in a bidirectional or unidirectional fashion. For wireless communication protocols such as 802.11 WiFi or WiFi, a wireless network is used so that the remote control and the device can communicate with one another in longer ranges.

In one implementation, information or messages can be sent from the remote control to the device via a number of different wireless communication protocols. However, the appropriate wireless communication protocol is chosen according to the appropriate context, range and particular application in order to conserve power and resources. In addition, the device may also use a number of different wireless communication protocols to communicate with a wireless network, other devices, a cloud or other entities. The different wireless communication protocols reinforce one another. In other words, in case one wireless communication protocol fails or goes down, then another wireless communication protocol is there to take its place. Having multiple wireless communication protocols serve as auxiliary or parallel channels to one another increases the robustness and efficiency of the overall system.

Device Connected to Wireless Communication Protocols

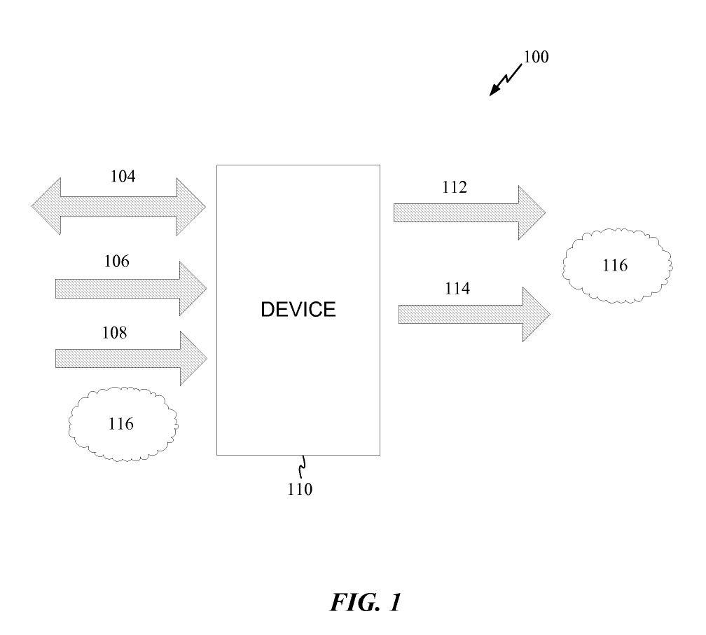

FIG. 1 is a schematic diagram of a device 110 using various wireless communication protocols according to an aspect of the present disclosure.

Device 110 may receive information or messages via bidirectional close-range protocol 104, unidirectional close-range protocol 106, or long-range protocol 108. The long-range protocol 108 may also be assisted by wireless network 116, which may include other devices, including remote controls, or connections to other devices.

An example of the bidirectional close-range protocol 104 is a ZigBee or Bluetooth connection because all that is required is the device 110 and another device (not shown) in communications with one another. In other words, the bidirectional close range protocol 104 does not require a wireless network to effectuate communications. This also means that the bidirectional close range protocol 104 uses less bandwidth (close to none), much less power and less resources compared to a wireless network protocol connection. The bidirectional close range protocol 104 also does not have congestion or traffic because it is not on a network, and would not be using frequency channels regulated by the FCC.

An example of the unidirectional close-range protocol 106 is ZigBee. For instance, the device 110 could be a smartphone and a store could be broadcasting an advertisement or similar message when the device 110 is within close proximity of the store, and within the necessary range for ZigBee transmissions. The unidirectional close-range protocol 106 also does not require a wireless network to communicate with the device 110. However, the device 110 must be close enough to the source broadcasting information via the unidirectional close-range protocol 106 in order to receive messages or information from it. The unidirectional close-range protocol 104 also has the advantages of less bandwidth, less power consumption, virtually no congestion or traffic, and not being on a frequency channel regulated by the FCC.

An example of the long-range protocol 108 is a 802.11 WiFi or WiFi connection. The long-range protocol 108 may also utilize the wireless network 116. For instance, the device 110 could be a smartphone and a store located far away from the device 110 (but in the same mall where the device 110 is present) could be broadcasting an advertisement. By using the wireless network 116, the advertisement broadcasted by that store will reach the device 110 via the long-range protocol 108.

However, the long-range protocol 108 compared to the close-range protocols of 104 and 106 may utilize more power, more resources, more bandwidth, and have frequency channels that may be regulated by the FCC. As a result, there are restrictions and costs associated with bandwidth usage over a wireless network 116 via long-range protocol 108. Therefore, the long-range protocol 108 should only be used when necessary—such as for performing long-distance communications—in order to conserve resources and power.

The device 110 may also use long-range export protocol 112 and close-range export protocol 114 to communicate with the wireless network 116 or other devices, which may also be located in the wireless network 116. An example of the long-range export protocol 112 is 802.11 WiFi or WiFi, as discussed above. The long-range export protocol 112 may both use the wireless network 116 as well as send information from the device 110 to the wireless network 116, or another device or receiver located within the wireless network 116. An example of the close-range export protocol 114 is ZigBee. In this case, the ZigBee connection would not need to use the wireless network 116 due to the nature of a ZigBee connection, but the device 110 may be communicating or sending information to another device or receiver within the wireless network 116 over the close-range export protocol 114. For instance, the device 110 may be sending information to another smartphone or device, or there may be a receiver in a store in the wireless network 116 that receives confirmation of user participation with regards to its advertisements.

Remote Control and Device with Wireless Communication Protocols

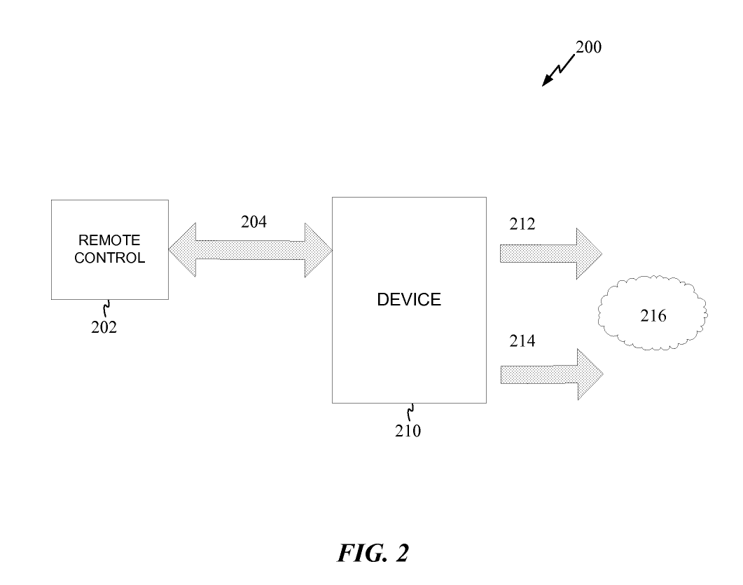

FIG. 2 is a schematic diagram 200 of a device 210 in communication with a remote control 202 and using various wireless communication protocols according to an aspect of the present disclosure.

The remote control 202 can send information and messages to device 210 via a bidirectional close-range protocol 204. An example of the bidirectional close-range protocol 204 is a ZigBee or Bluetooth connection. ZigBee or Bluetooth connections only require the remote control 202 and the device 210 to be in communications with one another. In other words, a wireless network is not necessary. Therefore, communications can take place between the remote control 202 and the device 210 much faster, with much less power consumption, and at a lower bandwidth. There may also be no FCC requirements or regulations on a ZigBee connection. Less resources are also utilized because the communications are made at a relatively close range. An example would be if the device 210 was a camera, and the remote control 202 was located in somewhat close proximity to the camera and configured to send the camera instructions such as turning on or off, or when to record video or shoot images. The bidirectional close-range protocol 204 may also involve the first submission of a message over Zigbee from the remote control 202 to the device 210, and then an acknowledgment message (or “ACK” message), sent back in response from the device 210 to the remote control 202.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. The long-range export protocol 212 may both use the wireless network 216 as well as send information from the device 210 to the wireless network 216, or another device or receiver located within the wireless network 216. An example of the close-range export protocol 214 is ZigBee. In this case, the ZigBee connection would not need to use the wireless network 216 due to the nature of a ZigBee connection, but the device 210 may be communicating or sending information to another device or receiver within the wireless network 216 over the close-range export protocol 214. For instance, the device 210 may be a camera sending data about its recorded video or taken shots to a computer for downloading and analysis. The device 210 may also be a smartphone that sends information to another smartphone or device, or there may be a receiver in a store in the wireless network 216 that receives confirmation of user participation with regards to its advertisements.

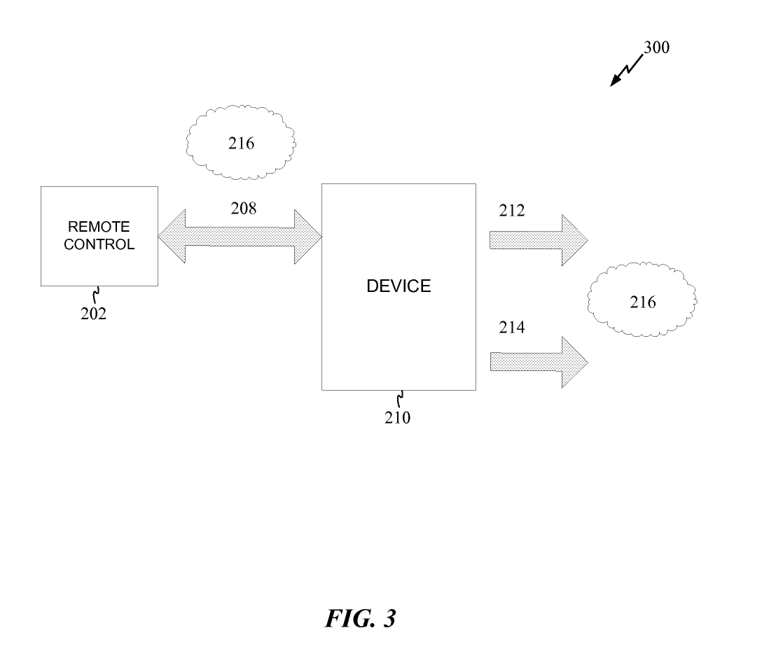

FIG. 3 is a schematic diagram 300 of a device 210 in communication with a remote control 202 and using various wireless communication protocols according to an aspect of the present disclosure.

The remote control 202 can send information and messages to device 210 via a bidirectional long-range protocol 208. An example of the bidirectional long-range protocol 208 is 802.11 WiFi or WiFi. The bidirectional long-range protocol 208 would also require the use of a wireless network 216. Even though communications with the bidirectional long-range protocol 208 over wireless network 216 may require more bandwidth, power and resources, communications over longer ranges may also be performed. In addition, the remote control 202 may access resources via the wireless network 216 through the bidirectional long-range protocol 208 that it wouldn't otherwise have access to with a ZigBee connection, for example. An example of this would be if the device 210 was a camera, and the remote control 202 needed to send the camera some information about sunlight settings during the day. However, the remote control 202 would need to access the wireless network 216 to retrieve that information, hence there are advantages of using a bidirectional long-range protocol 208 that has access to a wireless network 216. Likewise, in sending messages (such as acknowledgment messages or “ACK” messages) back from the device 210 to the remote control 202, the wireless network 216 can also be accessed in order to facilitate communications. For instance, if the device 210 is a camera and needs to send the remote control 202 information about different turn-on/turn-off schedules it can do so by accessing the wireless network 216 via the bidirectional long-range protocol 208.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above.

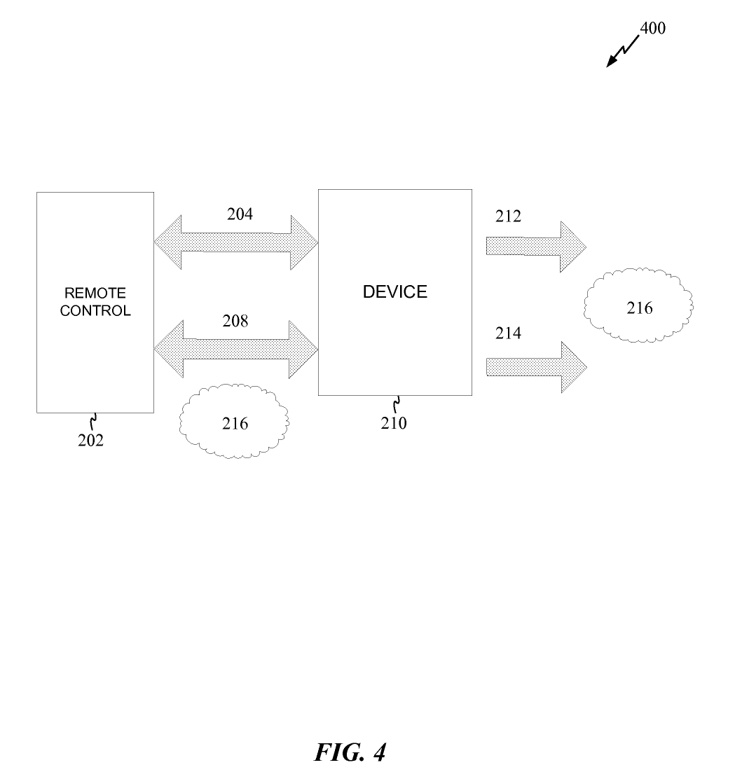

FIG. 4 is a schematic diagram 400 of a device 210 in communication with a remote control 202 and using various wireless communication protocols according to an aspect of the present disclosure.

As shown in FIG. 4, the remote control 202 may communicate with the device 210 by means of both a bidirectional close-range protocol 204 and a bidirectional long-range protocol 208. Both the bidirectional close-range protocol 204 and the bidirectional long-range protocol 208 are described above. However, being able to use both simultaneously has a number of advantages. First, in case one of the protocols 204 or 208 fails or drops off, another one is able to cover it. This is particularly useful when an important piece of information needs to be transmitted between the remote control 202 and the device 210. By using both the close-range and long-range channels as auxiliary or parallel channels, the security of information transfer between the remote control 202 and the device 210 is secured, as well as made more efficient. Another advantage is that information suited for a particular wireless communication protocol can be sent via a selected wireless communication protocol when appropriate, in order to make data communications more efficient. For instance, if the data is large and needs to be sent in a short amount of time, the ZigBee connection of the bidirectional close-range protocol 204 may be used as the quickest form of transfer. On the other hand, if the data is relatively small and can be sent over longer periods of time, then the WiFi connection of the bidirectional long-range protocol 208 may be used as the quickest form of transfer, with the wireless network 216 also being used to facilitate or further distribute the process.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above. Also, similar to what was discussed above, having both the long-range export protocol 212 and the close-range export protocol 214 be available simultaneously has advantages for security and efficiency purposes. For example, if one of the export protocols 212 or 214 fails or drops out, then the other one can cover. Furthermore, depending on the data to be sent, the appropriate export protocol out of 212 or 214 will be used in order to ensure the most efficient use of resources and power.

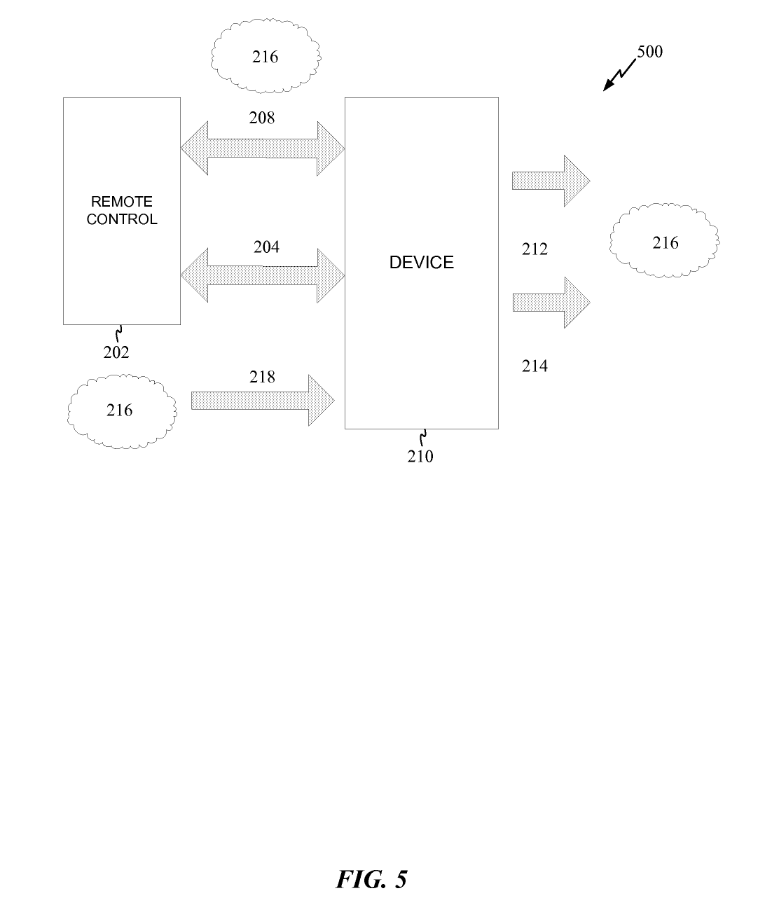

FIG. 5 is a schematic diagram 500 of a device 210 in communication with a remote control 202 and using various wireless communication protocols according to an aspect of the present disclosure.

As shown in FIG. 5, the remote control 202 may communicate with the device 210 by means of both a bidirectional close-range protocol 204 and a bidirectional long-range protocol 208, as well as a long-range protocol 218. Both the bidirectional close-range protocol 204 and the bidirectional long-range protocol 208 are described above, as well as the advantages of being able to use both simultaneously. The long-range protocol 218 could also be used in case the wireless network 216 contains another transmitter broadcasting content, and the device 210 is configured as a receiver of that content, being able to receive it as long as it is within the range of the long-range protocol 218. Examples of the long-range protocol 218 include 802.11 WiFi and WiFi. However, any type of long-range wireless communication protocol may be used.

The device 210 also may use the long-range export protocol 212 and the close-range export protocol 214 to communicate with the wireless network 216 or other devices, which may also be located in the wireless network 216. An example of the long-range export protocol 212 is 802.11 WiFi or WiFi, as discussed above. An example of the close-range export protocol 214 is ZigBee, also as discussed above. Also, similar to what was discussed above, having both the long-range export protocol 212 and the close-range export protocol 214 be available simultaneously has advantages for security and efficiency purposes. For example, if one of the export protocols 212 or 214 fails or drops out, then the other one can cover it. Furthermore, depending on the data to be sent, the appropriate export protocol out of 212 or 214 will be used in order to ensure the most efficient use of resources and power.

Process Flow

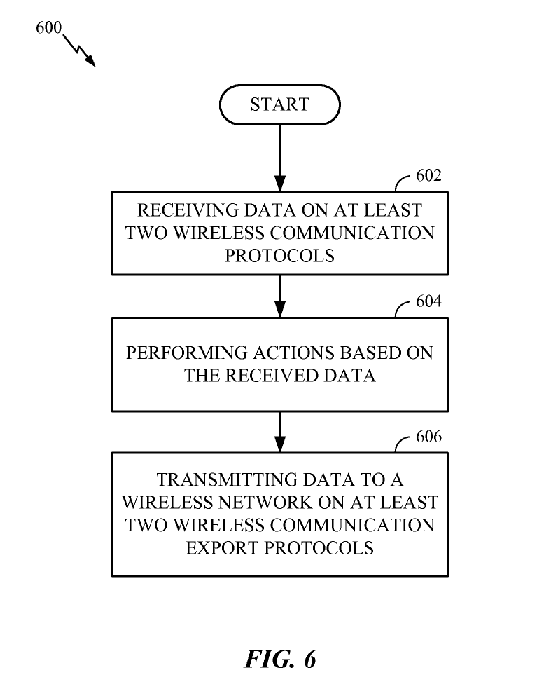

FIG. 6 is a process flow diagram illustrating a method 600 of using a remote control to communicate with a device using various wireless communication protocols, according to an aspect of the present disclosure.

In block 602, data is received on at least two wireless communication protocols. In block 604, actions are performed based on the received data. In block 606, data is transmitted to a wireless network on at least two wireless communication export protocols.

Implementation Alternatives

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The foregoing description of one or more embodiments or aspects of the present disclosure has been presented for the purposes of illustration and description. It is not intended to be exhaustive or to limit the disclosure or the invention to the precise form disclosed. Many modifications and variations are possible in light of the above teaching. Although the present disclosure and invention has been described in connection with certain embodiments, it is to be understood that modifications and variations may be utilized without departing from the principles and scope of the disclosure or invention, as those skilled in the art will readily understand. Accordingly, such modifications would be practiced within the scope of the disclosure and invention, and within the scope of the following claims or within the full range of equivalents of the claims.

Further, the attached claims are presented merely as one aspect of the present invention. No disclaimer is intended, expressed, or implied for any claim scope of the present invention through the inclusion of this or any other claim language that is presented herein or may be presented in the future. Any disclaimers, expressed or implied, made during prosecution of the present application regarding the claims presented, changes made to the claims for clarification, or other changes made during prosecution, are hereby expressly disclaimed for at least the reason of recapturing any potential disclaimed claim scope affected by presentation of specific claim language during prosecution of this and any related applications. Applicant reserves the right to file broader claims, narrower claims, or claims of different scope or subject matter, in one or more continuation or divisional applications in accordance within the full breadth of the present disclosure, and the full range of doctrine of equivalents of the present disclosure, as recited in this specification.

What is claimed is:

1. A system, comprising:
a remote control;
a device coupled to the remote control by a plurality of wireless communication protocols; and
a wireless network coupled to the device by a plurality of wireless communication export protocols.

2. The system of claim 1, in which the plurality of wireless communication protocols comprises a long-range wireless communication protocol and a close-range wireless communication protocol.

3. The system of claim 2, in which the remote control is further coupled to the wireless network by the long-range wireless communication protocol.

4. The system of claim 1, in which the plurality of wireless communication export protocols comprises a long-range wireless export communication protocol and a close-range wireless export communication protocol.

5. The system of claim 2, in which the long-range wireless communication protocol comprises 802.11 WiFi and WiFi.

6. The system of claim 2, in which the close-range wireless communication protocol comprises ZigBee and Bluetooth.

7. The system of claim 4, in which the long-range wireless communication export protocol comprises 802.11 WiFi and WiFi.

8. The system of claim 4, in which the close-range wireless export communication protocol comprises ZigBee and Bluetooth.

9. The system of claim 1, in which the wireless network is directly coupled to the device by a long-range protocol.

10. The system of claim 9, in which the long-range protocol comprises 802.11 WiFi and WiFi.

11. The system of claim 1, in which the remote control is configured to communicate with a first device with a first wireless communication protocol and a second device with a second wireless communication protocol.

12. The system of claim 1, in which the remote control is configured to communicate with the device with a first wireless communication protocol and also configured to communicate with the first wireless device with at least a second wireless communication protocol.

13. The system of claim 1, in which the remote control is configured to communicate with an internet server to upgrade a firmware of the remote control.

14. The system of claim 1, in which the remote control is configured to indicate a battery level to at least one of the device and an internet server.

15. The system of claim 1, in which the remote control comprises a functionality also present on the device, in which the functionality on the remote control does not interfere with the functionality on the device.

16. The system of claim 1, in which the remote control is configured using a password protection.

17. The system of claim 1, in which the remote control is configured to remove power to a communication circuit of the remote control when the communication circuit is idle.

18. The system of claim 1, in which the remote control is selectively configured to remove power to a transmit circuit and/or a receive circuit based on a command received by the remote control.

19. A method to communicate over wireless communication protocols, comprising:
receiving data on at least two wireless communication protocols;
performing actions based on the received data; and
transmitting data to a wireless network on at least two wireless communication export protocols.

20. The method of claim 19, in which the at least two wireless communication protocols comprises a long-range wireless communication protocol and a close-range wireless communication protocol.

21. The method of claim 20, in which the long-range wireless communication protocol comprises 802.11 WiFi and WiFi.

22. The method of claim 20, in which the close-range wireless communication protocol comprises ZigBee and Bluetooth.

23. The method of claim 19, in which the at least two wireless export communication protocols comprises a long-range wireless export communication protocol and a close-range wireless communication protocol.

24. The method of claim 23, in which the long-range wireless export communication protocol comprises 802.11 WiFi and WiFi.

25. The method of claim 23, in which the close-range wireless export communication protocol comprises ZigBee and Bluetooth.

26. The method of claim 19, further comprising:
receiving data from the wireless network over a long-range protocol.

27. The method of claim 26, in which the long-range protocol comprises 802.11 WiFi and WiFi.

28. The method of claim 19, further comprising:
if one of the at least two wireless communication protocols fail, then having another wireless communications protocol take over; and
if one of the at least two wireless export communication protocols fail, then having another wireless communications protocol take over.

29. The method of claim 19, further comprising communicating with a first device on a first wireless communication protocol communicating with a second device on a second wireless communication protocol.

30. The method of claim 19, further comprising communicating with a device on a first wireless communication protocol and on at least a second wireless communication protocol.

31. The method of claim 19, further comprising upgrading a firmware of a remote control on at least one of the wireless communication protocols.

32. The method of claim 19, further comprising indicating a battery level on at least one of the wireless communication protocols.
